(19) United States
(12) Patent Application Publication
(10) Pub. No.: US 2020/0160215 A1
(43) Pub. Date: May 21, 2020

(54) METHOD AND SYSTEM FOR LEARNING NUMERICAL ATTRIBUTES ON KNOWLEDGE GRAPHS

(71) Applicant: NEC Laboratories Europe GmbH, Heidelberg (DE)

(72) Inventors: Bhushan Kotnis, Heidelberg (DE); Alberto Garcia Duran, Heidelberg (DE)

(21) Appl. No.: 16/434,208

(22) Filed: Jun. 7, 2019

Related U.S. Application Data
(60) Provisional application No. 62/768,149, filed on Nov. 16, 2018.

(51) Int. Cl. G06N 20/00; G06N 5/02; G06F 7/544; G06F 17/16; G06N 5/04

(52) U.S. Cl. CPC G06N 20/00; G06N 5/02; G06N 5/047; G06F 17/16; G06F 7/544

(57) ABSTRACT

A method for learning numerical attributes in a knowledge graph includes learning knowledge graph embeddings based on jointly minimizing a knowledge graph loss and a number of numerical attribute prediction losses. The method also includes executing a numerical attribute propagation algorithm using an adjacency matrix of the knowledge graph and numerical values of labeled nodes of the knowledge graph to predict missing ones of the numerical attributes.

### CROSS-REFERENCE TO RELATED APPLICATION

Priority is claimed to U.S. Provisional Patent Application No. 62/768,149, filed on Nov. 16, 2018, the entire disclosure of which is hereby incorporated by reference herein.

### FIELD

The present invention relates to a method and system for learning numerical attributes on knowledge graphs.

### BACKGROUND

Real world entities (such as, persons, places, named objects, etc.) are often associated with numerical attributes. For example, a human is associated with date of birth, height, weight, etc., while a city is associated with latitude, longitude, area, etc. Such entities are often connected with one another through different types of relations such as ‘person/bomIn’ or ‘city/locatedIn’, etc. Such a structure where entities are connected to one another through relationships is termed as a knowledge graph (KG).

Knowledge graphs are playing an increasingly important role in a number of AI applications. Knowledge graphs can be characterized as a collection of facts or triples, for example: (HEAD, PREDICATE, TAIL), denoted as (h; p; t)—where head and tail correspond to entities and predicate corresponds to a relationship that holds between these two entities; or (SUBJECT, PREDICATE, OBJECT), denoted (s; p; o)—where p is the predicate (or relationship) connecting the subject entity s and the object entity o. This structured information is easily accessible by AI systems to enhance their performance.

A variety of AI applications, such as recommender systems, natural language chatbots, and question answering models, have benefited from the rich structural information archived in knowledge graph repositories. This is because much of human knowledge can be expressed with one or more conjunctions of knowledge facts

However, knowledge graphs' capabilities can be limited due to their incompleteness. Consequently there has been research on knowledge graph completion methods, for example, relationship extraction (see, e.g., Riedel et. al., “Relation extraction with matrix factorization and universal schemas,” Proceedings of the 2013 Conference of the North American Chapter of the Association for Computational Linguistics: Human Language Technologies, pp. 24-84 (2013) (i.e., classification of semantic relationship mentions) (the entire contents of which are hereby incorporated by reference herein)); knowledge graph matching (see, e.g., Suchanek et al. “Paris: Probabilistic alignment of relations, instances, and schema,” Proceedings of the VLDB Endowment, 5 (3), 157-168 (2011); Lacoste-Julien et al. “Sigma: Simple greedy matching for aligning large knowledge bases,” Proceedings of the 19th ACM SIGKDD International Conference on Knowledge Discovery and Data Mining, pp. 572-580 (2013) (i.e., alignment and integration of entities and predicates across KBs) (the entire contents of each of which are hereby incorporated by reference herein)); and search-based question-answering (see, e.g., West et. al, “Knowledge base completion via search-based question answering,” Proceedings of the 23^{rd} International Conference on World Wide Web, pp. 515-526 (2014) (i.e., queries issued to a web-search engine) (the entire contents of which are incorporated by reference herein)) are a few different ways to address the incompleteness problem.

Another approach are so-called link prediction methods (see, e.g., Nickel et. al, “A review of relational machine learning for knowledge graphs,” Proceedings of the IEEE, 104 (1), 11-33 (2016) (the entire contents of which are hereby incorporated by reference herein). Contrary to other solutions, link prediction methods aim to and missing links between entities exclusively based on the existing information contained in the knowledge graph by ranking entities that are answer candidates for the query. The queries these methods typically address are of the form (USA, /location/contains, ?), or (Madrid,/location/capitalOf, ?), whereas the missing element—represented by a question mark—is an entity contained in the knowledge graph.

Many link prediction methods only harness feature types learned from the rich relational information contained in the knowledge graph to infer new links, and only very recently (see, e.g., Garcia-Duran & Niepert, “Kblrn: End-to-end learning of knowledge base representations with latent, relational, and numerical features,” Uncertainty in Artificial Intelligence-Proceedings of the 34^{th} Conference (2018); Pezeshkpour et al., “Embedding multimodal relational data for knowledge base completion,” Empirical Methods in Natural Language Processing (2018) (the entire contents of each of which are hereby incorporated by reference herein)) numerical attributes have been integrated along with other feature types to improve link prediction performance. Similarly, numerical information is also represented as facts such as (Berlin, /location/latitude, 52.31) or (Albert Einstein, /person/birth year, 1879). However, the application of numerical attributes is limited because of the same incompleteness problem: Many entities are missing numerical attribute values they are expected to possess.

Additional background information can be found, for example, in Allison, P. D., “Missing data,” Sage, vol. 136 CA (1999), the entire contents of which are hereby incorporated by reference herein.

### SUMMARY

An embodiment of the present invention provides a method for learning numerical attributes in a knowledge graph. This method can include learning knowledge graph embeddings based on jointly minimizing a knowledge graph loss and a number of numerical attribute prediction losses. The method can also include executing a numerical attribute propagation algorithm using an adjacency matrix of the knowledge graph and numerical values of labeled nodes of the knowledge graph to predict missing ones of the numerical attributes.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 illustrates and example of a knowledge graph with missing numerical attributes;

FIG. 2 is a flow diagram illustrating an embodiment of a method for learning numerical attributes in a knowledge graph according to the present invention;

FIG. 3 illustrates a knowledge graph in a health care embodiment; and

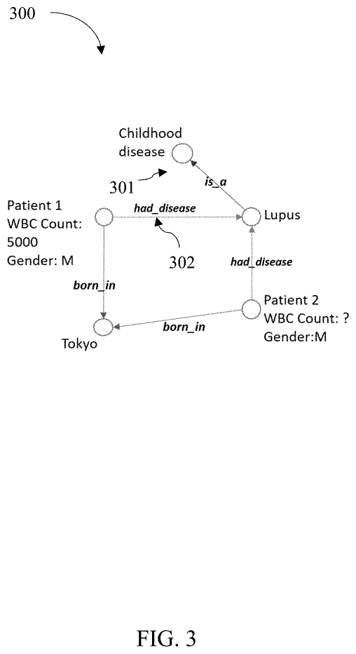

FIG. 4 illustrates a processing system for implementing an embodiment of the present invention.

### DETAILED DESCRIPTION

Embodiments of the present invention, address a problem of predicting missing numerical attributes in knowledge graph entities (referred to herein as the numerical attribute prediction problem).

Embodiments of the present invention incorporate an additional learning objective in knowledge graph embedding methods to learn feature representations of nodes that are enriched with numerical information. Embodiments use the learned feature representations to build a similarity graph on which numerical attributes are propagated across the graph via an improved label propagation technique.

According to an embodiment, a method is provided for predicting numerical attributes of entities in a knowledge graph by leveraging the graph structure. The method includes enhancing knowledge graph embeddings to capture the graph structure and known numerical attribute information through a multi-task learning formulation. The method implements numerical attribute propagation (NAP), which is a semi-supervised algorithm. In an embodiment the numerical attribute propagation is improved label propagation, which is enhanced by techniques of the present invention to predicting numerical attributes in a knowledge graph. In an embodiment, the label propagation algorithm has been enhanced to propagate numerical information across the graph structure instead of propagating class label information.

According to an embodiment of the present invention, a method is provided for learning numerical attributes in a knowledge graph. The method includes the following operations: (1) learning knowledge graph embeddings by jointly minimizing a knowledge graph loss and a number of numerical attribute prediction losses; and for each of the numerical attributes being predicted: (2) constructing a k-nearest neighbor (kNN) graph—characterized as an adjacency matrix-using the learned embeddings of labeled and unlabeled nodes—with respect to a numerical attribute-based on a suitable distance (e.g., a Euclidean distance); (3) computing edge weights of the adjacency matrix by applying a similarity metric; and (4) feeding the adjacency matrix of the graph along with the numerical values of labeled nodes as an input to a numerical attribute propagation (NAP) algorithm. In an embodiment, the method includes tuning a hyper-parameter k of the kNN graph. The tuning of the hyper-parameter k may be done concurrently and/or in conjunction with operation 2. In an embodiment, the method includes tuning the hyperparameters of the similarity metric. According to an embodiment, the hyperparameters of the similarity metric may be tuned only if they exist. The turning of the hyperparameters may be done concurrently and/or in conjunction with operation 3 above. According to another embodiment, a specialized computer system is provided to perform methods of the present invention.

An embodiment of the present invention provides a method for learning numerical attributes in a knowledge graph. The method can include: learning knowledge graph embeddings based on jointly minimizing a knowledge graph loss and a number of numerical attribute prediction losses; and executing a numerical attribute propagation algorithm using an adjacency matrix of the knowledge graph and numerical values of labeled nodes of the knowledge graph to predict missing ones of the numerical attributes.

The numerical attribute propagation algorithm can include: computing a transition matrix T by row-wise normalizing the adjacency matrix; and using the transition matrix T to iteratively propagate the numerical values across the knowledge graph until a stopping criterion is reached.

In an embodiment, the numerical attribute propagation algorithm includes solving:

\hat{n}_{Q}_{^{a}}^{a}=(I+T_{Q}_{^{a}}_{Q}_{^{a}})⁻¹T_{Q}_{^{a}}_{ε}_{^{a}}n_{ε}_{^{a}}^{a}.

Here, a is a numerical attribute of the knowledge graph, ε^{a} is a set of entities of the knowledge graph with known values for the numerical attribute a, Q^{a} is a set of entities of the knowledge graph with missing values for the numerical attribute a, \hat{n}_{Q}_{^{a}}^{a} is a vector that contains all predicted values of the numerical attribute a for unlabeled nodes of the knowledge graph, I is an identity matrix, T_{Q}_{^{a}}_{Q}_{^{a}} and T_{Q}_{^{a}}_{ε}_{^{a}} are sub-matrices of a transition matrix T, which is computed by row-wise normalizing the adjacency matrix, and n_{ε}_{^{a}}^{a} is a vector that contains all values of the numerical attribute a for the labeled nodes.

The numerical attribute propagation algorithm can be executed for each of the missing numerical attributes being predicted. For each of the missing numerical attributes, a k-nearest neighbor (kNN) graph can be calculated using the learned knowledge graph embeddings, the kNN graph for each of the missing numerical attributes being characterized by the adjacency matrix of the corresponding one of the missing numerical attributes. Edge weights of the adjacency matrix can be computed by applying a similarity metric.

In an embodiment, the kNN graph is constructed based on Euclidian distance.

In an embodiment, the learned knowledge graph embeddings includes learned knowledge graph embeddings of the labeled nodes and learned knowledge graph embeddings of unlabeled nodes of the knowledge graph.

In an embodiment, the similarity metric is a radial basis function kernel.

The knowledge graph can have entities containing the numerical attributes.

According to an embodiment, the method further includes the operation of tuning a hyper-parameter of the kNN graph.

The method may also include tuning a hyper-parameter of the similarity metric.

The numerical attribute propagation algorithm can be an adapted label propagation algorithm, adapted for predicting the numerical attributes in the knowledge graph.

The adapted label propagation algorithm can be adapted to propagate the numerical information across the knowledge graph instead of propagating class label information.

The learning of the knowledge graph embeddings operation can include using a regression model.

The jointly minimizing the knowledge graph loss and the numerical attribute prediction losses can include using a loss function [symbol] . The loss function [symbol] can be expressed as:

$$= {ℒ}_{KG} + {\sum }_{a ∈ A} {\sum }_{e ∈ {ɛ}^{a}} {( {e}^{T} {w}^{a} + {b}^{a} - {n}_{e}^{a} )}^{2} + {λ}_{a} {‖ {w}^{a} ‖}_{2}^{2}$$

Here, [symbol] _{KG} is a loss function of the knowledge graph, a is numerical attribute of a set of numerical attributes A of the knowledge graph, e is an entity of a set of entities ε^{a} of the knowledge graph with known values for the numerical attribute a, e^{T}w^{a}+b^{a} is a regression function for the numerical attribute a, λₐ is a regularization hyper-parameter, w^{a} is a weight vector, and b^{a} is a bias term.

Another embodiment of the present invention provides a system for learning numerical attributes in a knowledge graph. The system includes a processor and memory, the memory storing information that when executed causes the processor to: instantiate a regression model to learn knowledge graph embeddings based on jointly minimizing a knowledge graph loss and a number of numerical attribute prediction losses; and execute a numerical attribute propagation algorithm using an adjacency matrix of the knowledge graph and numerical values of labeled nodes of the knowledge graph to predict missing ones of the numerical attributes.

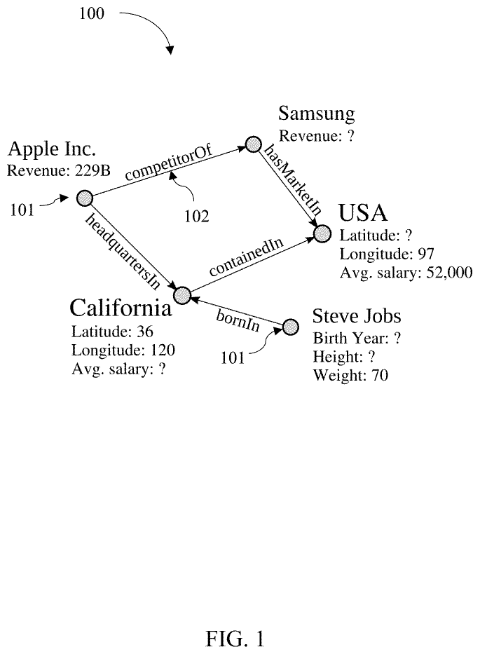

FIG. 1 illustrates a knowledge graph 100. The knowledge graph 100 includes several entities 101 (or nodes) connected by edges 102. The edges 102 represent the known relationships between entities 101 (a relationship attribute). For example, the Apple Inc. entity, is connected to the California entity by the edge with the attribute headquartersIn, representing that the company Apple Inc. headquarters is in California. This is a ‘fact’ of the knowledge graph, which can be represented by the triple, (Apple Inc.; headquartersIn; California), where Apple Inc. is the ‘head’ entity, California is the ‘tail entity’, and headquartersIn is the ‘predicate.’

The entities 101 also have one or more attributes associated with them. For example, the Apple Inc. entity includes a revenue attribute with the value 229B. This represents the ‘fact’ of the knowledge graph that Apple Inc. has a revenue of $229 billion. As a triple, this can be represented as: (Apple Inc.; Revenue; 229B), with Apple Inc. being the ‘subject’ entity, 229B, the ‘object’ entity, and Revenue the ‘predicate. Here, because the value of the attribute is a number, it is referred to as a numerical attribute.

As shown in FIG. 1, some of the entities 101 are missing values for their numerical attributes, for example, (Samsung, revenue,?) or (California, average_salary, ?). Embodiments of the present invention address a problem of answering knowledge graph queries where the query predicate is a numerical attribute with a missing value. The answer to this type of query is a numerical value.

Notationally, a knowledge graph can be defined as G=(ε, P), where ε is a set of entities and P is a set of relation types or predicates. Once again, the knowledge graph is a collection of facts represented by triples. For example, for the tipple (h; p; t), pεP and h; t ϵε. Further, a knowledge graph enriched with numerical attributes can be defined as G_{NA}=(G, A, N), indicating that entities in G are associated with numerical values N via numerical attributes (numerical predicates) A. This information can also be expressed as a collection of facts represented by triples. For example, for the triple (h; pₐ; t), pₐ ϵ A, h ϵ ε, and t ϵ N.

Embodiments of the present invention provide numerical attribute prediction that seeks to determine the most probable completion of a fact (h; pₐ; ?), where h ϵ ε, pₐ ϵ A, and ? ϵ N. As used herein, ε^{a} is a set of entities for which the value of a numerical attribute a is known—where ε^{a} is a subset of ε—e is an entity with the numerical attribute a, and the known numerical value for attribute a is nₑ^{a}. Embodiments of the present invention, then provide a mechanism to learn a function ƒ: ε→R, R denoting the set of reals.

Embodiments of the present invention leverage the graph structure of the knowledge graph (KG) to predict entity numerical attributes. In embodiments, the assumption is made that there is an underlying generative model that (partially) determines the relational structure of the knowledge graph based on the values that entities' numerical attributes take on. This assumption has been verified by experiments in two data sets with different degrees of sparsity.

The methodology implemented by embodiments of the present invention to address the above-described numerical attribute prediction problem includes the following two operations: (1) learning knowledge graph embeddings; and (2) execute a numerical attribute propagation algorithm.

According to an embodiment of the present invention, knowledge graph embeddings are learned by jointly minimizing a knowledge graph loss and a number of numerical attribute prediction losses. Embodiments of the present invention provide a technological improvement over state of the art knowledge graph embedding learning methods by, for example, combining knowledge graph loss with numerical attribute prediction losses for joint training.

Knowledge graph embeddings include latent representations for the nodes of the knowledge graph and relationships contained in the knowledge graph. Knowledge graph embeddings are related to tensor factorization methods. See Nickel et. al, “A Review of Relational Machine Learning for Knowledge Graphs,” Proceedings of the IEEE, 104(1), pp. 11-33 (2016) (the entire contents of which are hereby incorporated by reference herein). These embeddings explain, to some extent, the relational structure of the knowledge graph.

For the sake of simplicity, embodiments of the method according to the present invention are explained in relation to TransE (see Bordes, A., Usunier, N., Garcia-Duran, A., Weston, J. and Yakhnenko, O., “Translating Embeddings for Modeling Multi-relational Data,” Advances in Neural Information Processing Systems, pp. 2787-2795 (2013) (the entire contents of which are hereby incorporated by reference herein)); however, the process of the present invention is agnostic to the knowledge graph embedding method chosen. As such, the present invention is not limited to the TransE application.

TransE represents relationships as translations between entities in the embedding space by optimizing a certain scoring function f. Here, eₛ, eₒ, and eₚ are the embeddings (feature representations) of the entity subject, the entity object, and the predicate of a certain triple, respectively. The value of the scoring function on a triple (s, p, o), f(s,p,o), is learned to be proportional to the likelihood of the triple being true. It should output high values for triples expressing true information, and low values for triples expressing false information. An example of the scoring function is shown below:

TransE: f(s,p,o)=−∥eₛ+eₚ−eₒ∥2.

where eₛ, eₒ ϵR^{d} are the embeddings of the subject and object entities, eₚ ϵR^{d} is the embedding of the relation type predicate, and d is a hyperparameter of the model related to the dimensionality of the embeddings. Without loss of generality, these embeddings can be learned by optimizing a knowledge graph loss [symbol] _{KG}.

The knowledge graph loss [symbol] _{KG} function may be a logarithmic loss function:

$${KG}_{} = - {\sum }_{d ∈ D} log p ( d \vert θ )$$

where parameters θ are learned for minimizing [symbol] _{KG} with stochastic gradient decent, here d is a fact, i.e., a triple (h, p, t), and p is the probability for a fact being true.

The numerical attribute information is incorporated in the knowledge graph embeddings by simultaneously learning to predict numerical attributes from the embeddings using a number of regression models. Here, ε^{a} is the set of labeled entities for numerical attribute a. That is, the set of entities for which the numerical attribute a is known. Therefore, the full loss function to optimize is given by:

$$= {ℒ}_{KG} + {\sum }_{a ∈ A} {\sum }_{e ∈ {ɛ}^{a}} {( {e}^{T} {w}^{a} + {b}^{a} - {n}_{e}^{a} )}^{2} + {λ}_{a} {‖ {w}^{a} ‖}_{2}^{2}$$

The first term corresponds to the knowledge graph loss [symbol] _{KG}, and the second term is the mean squared error between the actual values and the predictions for all numerical attributes and for all entities possessing that numerical attribute in the training data. Learning embeddings by jointly minimizing these two losses infuses the embedding vectors with numerical attribute information. The inventors have termed these embeddings that are enriched with numerical attribute information as TransE++.

Furthermore, for the above loss function, a is numerical attribute of a set of numerical attributes A of the knowledge graph, e is an entity of a set of entities ε^{a} of the knowledge graph with known values for the numerical attribute a, e^{T}w^{a}+b^{a} is a regression function for the numerical attribute a, λₐ is a regularization hyper-parameter (e.g., the /2 regularizer), w^{a} is a liner regression weight vector, b^{a} is a bias term. While the present embodiment uses a linear regression function, other regression functions are possible.

As stated above, the second operation of methods of embodiments of the present invention is to execute a numerical attribute propagation algorithm.

According to embodiments, the numerical attribute propagation algorithm is feed with an adjacency matrix of the knowledge graph along with numerical values of labeled nodes of the knowledge graph.

Embodiments may use TransE++ embeddings to create the adjacency matrix (graph) between the labelled (entities with known numerical attribute value) and unlabeled entities (entities for which we want to predict the numerical attribute value) for a given numerical attribute. This can be done by generating a k-Nearest Neighbors (kNN) graph using a suitable distance metric (e.g., a Euclidean distance metric). The edge weights of the adjacency matrix are obtained by applying a similarity function (e.g., a radial basis function kernel) between the learned representations of entity pairs. This graph is used to predict the value of unlabeled entities for the given numerical attribute.

Embodiments can be implemented by enhancing a semi-supervised algorithm-Label Propagation (see Zhu, X and Ghahramani, Z., “Learning from Labeled and Unlabeled Data with Label Propagation, CMU-CALD-02-107 (2002) (the entire contents of which are hereby incorporated by reference herein)—to propagate numerical attribute values from the labelled entities to the unlabeled entities through the constructed graph. Typically, label propagation propagates class label information in a graph. Instead, embodiments replace class labels by numerical attribute values. This is done by first computing the transition matrix T by row-wise normalizing the adjacency matrix. Without loss of generality, embodiments arrange labeled and unlabeled data so that T can be decomposed as:

$$T = [ \begin{matrix}{T}_{{ɛ}^{a} {ɛ}^{a}} & {T}_{{ɛ}^{a} {Q}^{a}} \\ {T}_{{Q}^{a} {Q}^{a}} & {T}_{{Q}^{a} {ɛ}^{a}}\end{matrix} ]$$

where Q^{a} is the set of unlabeled entities for numerical attribute a. That is, the set of entities for which we want to predict the numerical attribute a.

The transition matrix T can be used to iteratively propagate numerical information across the graph until a stopping criterion is reached. This is an embodiment of a numerical attribute propagation algorithm of the present invention.

Alternatively, embodiments can implement a numerical attribute propagation algorithm using the closed form solution:

\hat{n}_{Q}_{^{a}}^{a}=(I+T_{Q}_{^{a}}_{Q}_{^{a}})⁻¹T_{Q}_{^{a}}_{ε}_{^{a}}n_{ε}_{^{a}}^{a}

where \hat{n}_{Q}_{^{a}}^{a} are predictions, and n_{ε}_{^{a}}^{a} are labelled attribute values. Also, a is a numerical attribute of the knowledge graph, ε^{a} is a set of entities of the knowledge graph with known values for the numerical attribute a, Q^{a} is a set of entities of the knowledge graph with missing values for the numerical attribute a, \hat{n}_{Q}_{^{a}}^{a} is a vector that contains all predicted values of the numerical attribute a for unlabeled nodes of the knowledge graph, I is an identity matrix, T_{Q}_{^{a}}_{Q}_{^{a}} and T_{Q}_{^{a}}_{ε}_{^{a}} are sub-matrices of a transition matrix T, and n_{ε}_{^{a}}^{a} is a vector that contains all values of the numerical attribute a for the labeled nodes.

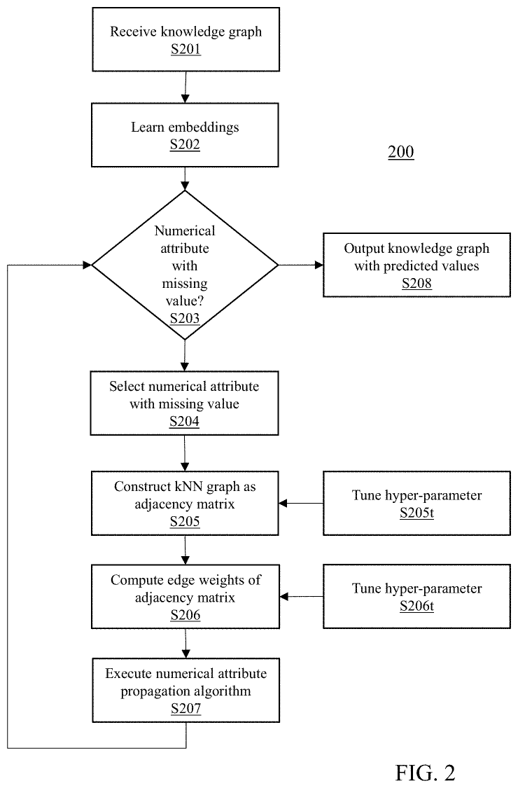

FIG. 2 is a flow diagram illustrating an embodiment of a method 200 for learning numerical attributes in a knowledge graph according to the present invention.

At the outset, a knowledge graph is received (S201). The knowledge graph includes entities (e.g., nodes) with numerical attributes, and at least one entity is missing a value for its numerical attribute. The method 200 is executed on the knowledge graph to predict the missing value (or values).

Embeddings of the entities of the knowledge graph are then learned (S202). According to an embodiment, embeddings are first learned from non-numerical attributes (or facts), and then the non-numerical embeddings are used along with numerical attributes to train a machine leaning model for predicting the numerical attributes. The machine learning model may be a regression model (such as a regression model using a linear regression function). In an embodiment, the method 200 learns the knowledge graph embeddings by jointly minimizing a knowledge graph loss and a numerical attribute prediction loss.

The method 200 may be configured to operate until all predictions are made for numerical attributes with missing values. Accordingly, the method determines whether (at the current state) there is a numerical attribute of the knowledge graph where a value requires prediction (S203). The following operations (S204-S208) of the method 200 are then executed for each of numerical attributes were a prediction needs to be made.

A numerical attribute with a missing value is selected (S204). For example, in a scenario where there is a set of numerical attributes with missing values {a₀, a₁, . . . aᵢ}, the method may initially select the first numerical attribute a₀ of that set.

For the selected numerical attribute, a k-nearest neighbor (kNN) graph is constructed using the learned embeddings from operation S202 that correspond to the selected numerical attribute (S205). In an embodiment, the kNN graph is constructed based on a suitable distance (e.g., a Euclidian distance). The kNN graph is characterized by an adjacency matrix. One or more hyper-parameter of the kNN graph may be tuned (S205t) (e.g., before, concurrent with, or after conducting operation S205).

Edge weights of the adjacency matrix are then computed by applying a similarity metric (S206). One or more hyper-parameter of the similarity metric may be tuned (S206t) (e.g., before, concurrent with, or after conducting operation S206).

A numerical attribute propagation algorithm is then executed to predict the missing values for the selected numerical attribute (S207). The numerical attribute propagation algorithm can take as its input the adjacency matrix and the numerical values from the set of entities for which the selected numerical attribute is known (i.e., labeled entities or nodes). In an embodiment, the numerical attribute propagation algorithm computes a transition matrix by row-wise normalizing the adjacency matrix, and then the translation matrix is used to iteratively propagate numerical information across the graph until a stopping criterion is reached.

Once the missing values for the selected numerical attribute are predicted by the numerical attribute propagation algorithm, the method 200 determines whether there is another numerical attribute with missing values (S203). If no other numerical attribute has missing values, the method 200 outputs the knowledge graph with predicted values (S208). The method continues if there are more values to predict (S203-S207).

The present invention can be embodied in various different forms and applications. For example, an embodiment of the present invention may be implemented for health care, for example, for hospital data management.

Increasingly both large and small hospitals use hospital management software to keep track of patient data, treatment and outcomes, medical tests and other logistic information. This data is then used by doctors to track patient history, hospital management for automated billing and inventory management. Increasingly patient health data is used by bio-statisticians and health analytics systems for improving patient outcomes. Unfortunately patient records suffer from missing data, even data that is critical for treatment decisions. This may be due to, for example, problems in data entry, errors while scanning medical forms, or due to lack of time to collect data during medical emergencies.

Such patient data is often stored in large relational databases containing linked information. For example, such databases contain demographic information about patients, treatment and prescription history. This relational data can be used to construct a knowledge graph. Furthermore such a knowledge graph can be augmented with external information relating to diseases, symptoms and prescribed drugs. FIG. 2 illustrates such a knowledge graph 300.

Embodiments of the present invention are able to exploit this relational information to predict missing attributes. For example, the white blood cell (WBC) count could be predicted based on the fact that both patients had Lupus (an auto-immune disorder) which is known to reduce WBC count and were born Tokyo (Asians are more prone to suffer from Lupus). Embodiments of the present invention can capture these correlations leading to accurate prediction of missing numerical attributes.

Another embodiment of the present invention may be implemented in the financial industry (for example, in an insurance context).

Insurance companies often need to scan paper based applications from clients and customers. These applications contain customer data, policy data and agent revenues that are needed to keep track of policies, calculate premiums and assess risks. Due to scanning errors many numerical data fields often go unpopulated. Mistakes are made or numerical fields left empty even during data entry or while collecting data from customers and insurance agents. Thus missing data is a problem. There are many algorithms that aim to predict missing data, but none leverage the rich multi-relational connected structure of the underlying data.

A key insight is that the policy information and customer data in most insurance companies is stored in relational SQL databases. These databases contain different relationships between different insurance policies and their riders, locations and demographic details of insurance agents and customers and customer policy relations. Such relational tables can be converted to a knowledge graph. This will allows the algorithm of embodiments to harness the rich relational information along with numerical attribute information to complete missing numerical attributes such as event dates and missing demographic information with higher accuracy.

Experiments (described below) show the benefits of the approach of embodiments of the present invention in comparison to standard baselines. The benefits include higher accuracy and model robustness to data sparsity.

A simple and natural baseline is using the sample mean of the attribute specific training data as a predictor for missing values. This is known as mean imputation. At test time, given an entity e for which we aim to predict the value of numerical attribute a, denoted as \hat{n}ₑ^{a}, this baseline simply assigns the sample mean of all known entities possessing the same numerical attribute, that is ε^{a}. This is formally described below:

\hat{n}ₑ^{a}=ƒ({n_{e′}^{a}|e′ϵε^{a}})

Where ƒ is the sample mean. This baseline is called GLOBAL herein because it harnesses global information from the entire specific training set.

The second baseline takes into account that entities are interconnected through a relational graph structure. Thus, it is natural to define a baseline that exploits the neighborhood or local graph structure. For a numerical attribute a, this baseline estimates a value for the entity e as the average of its neighbors' attribute values for that numerical attribute. Here, the neighborhood of a node e, denoted Nₑ, is defined as the set of nodes that are connected to e though any relation type. This baseline is formalized as follows:

\hat{n}ₑ^{a}=ƒ({n_{e′}^{a}|e′ϵε^{a}∩Nₑ})

Were, ƒ is either the sample mean or the sample median depending on the evaluation metric. This baseline is called LOCAL because it uses the local neighborhood information for prediction.

Baselines and methods of the present invention have been evaluated by their ability to answer completion queries of the form (h; pₐ; ?), where h ϵ ε, pₐ ϵ A, and ? ϵ N. The baselines and models were evaluated on two benchmark datasets: FB15K-237 (see Toutanova et. al, “Representing text for joint embedding of text and knowledge bases,” Proceedings of the 2015 Conference on Empirical Methods in Natural Language Processing, pp. 1499-1509 (2015) (the entire contents of which is hereby incorporated by reference herein)) and YAGO15K (see Garcia-Duran, Dumancic, & Niepert, “Learning sequence encoders for temporal knowledge graph completion,” (2018) (the entire contents of which are hereby incorporated by reference herein).

The FB15K-237 dataset contains a total of 29,395 numerical facts divided in 116 different numerical predicates. The models were evaluated on the top 10 numerical attributes ranked by the number of data samples. This reduces the dataset to 22,929 samples. These numerical facts were split into training, validation and test in the proportion of 80/10/10%, respectively. All other facts from FB15K-237 whose predicate belongs to P were used as training data, which amounts to 310,116 facts. Thus, methods of the present invention were only evaluated on their ability to answer queries whose answer is a numerical value.

The YAGO15K dataset contains 23,520 numerical facts divided in 7 different attributes. Similarly, these numerical facts were split into training, validation and test in the same proportion. All other 122,886 facts from this dataset were used for learning knowledge graph embeddings. A summary of the datasets can be found in Table 1 (below).

TABLE 1
Dataset statistics.

| | Numerical Facts | | | Facts | | | |
|---|---|---|---|---|---|---|---|
| Dataset | train | dev | test | train | \|ε\| | \|P\| | \|A\| |
| FB15K-237 | 18,423 | 2,263 | 2,243 | 310,116 | 14,541 | 237 | 10 |
| YAGO15K | 18,872 | 2,330 | 2,318 | 122,886 | 15,404 | 32 | 7 |

Performance was compared across methods using two evaluation metrics —MAE and RMSE. These are standard metrics used in regression problems.

$$err ( e , a ) = {n}_{e}^{a} - {\hat{n}}_{e}^{a}$$

$$MAE ( a ) = \frac{1}{\vert {Q}^{a} \vert} {\sum }_{e ∈ {Q}^{a}} \vert err ( e , a ) \vert$$

$$RMSE ( a ) = \sqrt{\frac{1}{\vert {Q}^{a} \vert} {\sum }_{e ∈ {Q}^{a}} \vert {err ( e , a )}^{2} \vert}$$

For TransE and TransE++ the embedding dimension d was fixed to 100 in the experiments, and the weight a of TransE++ was fixed to 1. Adam (see Kingma & Ba, “Adam: A method for stochastic optimization,” arXiv: 1412.6980 (2014) (the entire contents of which is hereby incorporated by reference herein)) was used to learn the parameters in a mini-batch setting, with a learning rate of 0.001. In the experiments, the number of epochs was set to 100 and the mini-batch size was set to 256. The parameter N of the negative sampling was set to 50. Within a batch, the number of data points for each of the TransE++'s regression objectives was proportional to the frequency of each of the numerical predicates in the training set. In all cases, the parameters were initialized following Glorot & Bengio, “Understanding the difficulty of training deep feedforward neural networks,” Proceedings of the 13th International Conference on Artificial Intelligence and Statistics, pp. 249-256 (2010) (the entire contents of which are hereby incorporated by reference herein).

The Scikit-learn implementation of ridge regression was for the approaches LR (applying a linear regression model) and LR++. See Pedregosa et. al, “Scikit-learn: Machine learning in Python,” Journal of Machine Learning Research, 12, 2825-2830 (2011) (the entire contents of which is hereby incorporated by reference herein). The regularization term λ was tuned using the values [0; 0:1; 1; 10; 100].

For NAP and NAP++ the number of neighbors (k) of the kNN graph was validated among [3; 5; 10; 20]; and the σ of the RBF kernel is validated among [0:25; 0:5; 1; 10].

Tables 2 and 3 detail the performance of the baselines and methods of the present invention on FB15K-237. For each numerical attribute the best performing method is indicated in bold font, which most of the time was determined to be NAP or NAP++. From Table 2 we observe that for the numerical attributes ‘location.area’ and ‘population.number’, Global largely outperforms Local. This seems to indicate that the relational structure of this data set does not relate to these two numerical predicates. Overall, predictions for all other numerical attributes tend to benefit from the local information given by the entities' neighborhood. In comparing Tables 2 and 3, Local appears very competitive in regard to the numerical attributes ‘latitude’ and ‘longitude’. This can be explained by the presence of predicates such as ‘location.adjoins’ or ‘location.contains’ in the relational structure of the graph. Similarly, entities' neighborhoods are useful for predicting ‘date_of_birth’ or ‘date_of_death’ because (some of the) surrounding entities correspond to people who have similar birth or death dates. Interestingly, approaches of the present invention beat both baselines in the numerical attribute ‘person.height_mt’, for which a priori one would not expect performance gains in learning from the graph structure.

TABLE 2
Performance of GLOBAL and LOCAL on FB15K-237.

| | GLOBAL | | LOCAL | |
|---|---|---|---|---|
| Num. Attribute | MAE | RMSE | MAE | RMSE |
| location.area | ~3.1e⁴ | ~5.4e⁵ | ~3.7e⁶ | ~6.9e⁶ |
| latitude | 9.99 | 16.67 | 3.38 | 10.30 |
| date_of_birth | 31.40 | 124.07 | 19.76 | 54.20 |
| population_number | ~3.9e⁶ | ~1.7e⁶ | ~1.1e⁷ | ~3.9e⁷ |
| person.height_mt | 0.085 | 0.104 | 0.091 | 0.113 |
| film_release_date | 12.29 | 16.71 | 10.75 | 15.54 |
| longitude | 52.10 | 68.28 | 5.32 | 16.32 |
| org.date_founded | 72.18 | 121.013 | 79.4 | 133.24 |
| date_of_death | 33.69 | 71.51 | 27.64 | 68.37 |
| location.date_founded | 120.66 | 259.84 | 136.23 | 552.84 |

TABLE 3
Performance of L_{R}- and NAP- based models on FB15K-237

| | LR | | N_{AP} | | L_{R}++ | | N_{AP}++ | |
|---|---|---|---|---|---|---|---|---|
| Num. Attribute | MAE | RMSE | MAE | RMSE | MAE | RMSE | MAE | RMSE |
| location.area | ~7.7e⁵ | ~1.0e⁶ | ~5.1e⁵ | ~1.5e⁶ | ~8.9e⁵ | ~1.2e⁶ | ~2.9e⁵ | ~8.5e⁵ |
| latitude | 8.47 | 12.44 | 2.5 | 5.83 | 6.52 | 10.85 | 2.20 | 5.02 |
| date_of_birth | 26.60 | 116.58 | 16.42 | 78.18 | 25.73 | 109.66 | 12.16 | 23.71 |
| population_number | ~7.9e⁶ | ~1.7e⁷ | ~7.4e⁶ | ~2.3e⁷ | ~1.0e⁷ | ~1.9e⁷ | ~8.0e⁶ | ~3.3e⁶ |
| person.height_mt | 0.065 | 0.083 | 0.074 | 0.092 | 0.073 | 0.091 | 0.074 | 0.092 |
| film_release_date | 5.59 | 7.68 | 4.13 | 6.35 | 5.78 | 7.68 | 3.90 | 5.81 |
| longitude | 25.56 | 34.69 | 6.22 | 16.04 | 24.77 | 33.29 | 6.26 | 21.26 |
| org.date_founded | 53.85 | 90.11 | 51.28 | 84.99 | 56.04 | 100.58 | 53.47 | 92.75 |
| date_of_death | 35.89 | 56.84 | 24.77 | 62.62 | 37.27 | 48.71 | 19.535 | 33.324 |
| location.date_founded | 145.46 | 227.09 | 79.65 | 161.02 | 139.29 | 240.26 | 88.04 | 201.88 |

An observation from Table 3 is that, in general, NAP-based models perform much better compared to LR-based models. This enhanced performance may be because the numerical attribute propagation approaches learn from labeled and unlabeled data, whereas the regression models only learn from labeled data. Another reason for these performance observations may be due to because NAP's predictions are computed as a weighted average of observed numerical values, while LR's predictions are not bounded. This prevents NAP-based approaches from making large mistakes. On the other hand, for example, we observed non-plausible values (e.g. >2020) predicted by the LR-based models for the numerical attribute ‘date of birth’.

Knowledge graphs are known to suffer from data sparsity due to missing facts. The same incompleteness is also true for numerical facts. Accordingly models should be studied to observe model performance under a sparse data regime. Data sparsity was generated by artificially removing numerical facts from the training set while keeping the validation and test sets unchanged. The underlying knowledge graph G was kept unchanged because the approach was to isolate the effect of numerical fact sparsity. In other words, only numerical facts are removed from the training set. A percentage Pᵣ of training numerical facts were retained, and LOCAL and NAP++ were ran with the same experimental setup. The following values of Pᵣ were used in the experimentation: [1004, 80, 50, 20]%. The results of these experiments are shown in Table 4. The performance of LOCAL degrades more rapidly compared to NAP++ as the sparsity increases. Even in high regimes of sparsity, NAP++'s performance is remarkably robust.

TABLE 4
Performance of LOCAL and NAP++ on FB15K-237 for different degrees
of sparsity, Pᵣ on the numerical facts. Results are reported in terms of MAE.

| | Pᵣ | | | | | | | |
|---|---|---|---|---|---|---|---|---|
| | 100 | | 80 | | 50 | | 20 | |
| Num. Attribute | LOCAL | NAP++ | LOCAL | NAP++ | LOCAL | NAP++ | LOCAL | NAP++ |
| location.area | ~3.7e⁶ | ~2.9e⁵ | ~3.5e⁶ | ~5.0e⁵ | ~1.2e⁶ | ~4.0e⁵ | ~2.2e⁶ | ~2.3e⁵ |
| latitude | 3.38 | 2.20 | 3.85 | 2.19 | 5.08 | 3.28 | 7.206 | 4.40 |
| date_of_birth | 19.76 | 12.16 | 23.63 | 15.444 | 22.96 | 12.93 | 27.2 | 19.20 |
| population_number | ~1.1e⁷ | ~8.0e⁶ | ~1.2e⁷ | ~6.0e⁶ | ~9.09e⁶ | ~4.7e⁶ | ~5.2e⁷ | ~1.6e⁷ |
| person.height_mt | 0.091 | 0.074 | 0.094 | 0.073 | 0.092 | 0.076 | 0.096 | 0.008 |
| film_release_date | 10.75 | 3.90 | 10.88 | 4.36 | 10.83 | 4.33 | 11.303 | 4.69 |
| longitude | 5.32 | 6.26 | 8.53 | 6.2 | 18.29 | 9.7 | 31.857 | 10.57 |
| org.date_founded | 79.4 | 53.47 | 74.68 | 50.3 | 81.77 | 52.59 | 73.35 | 61.44 |
| date_of_death | 27.64 | 19.54 | 27.46 | 21.74 | 25.33 | 23.42 | 35.06 | 29.42 |
| location.date_founded | 136.2 | 88.04 | 136.6 | 117.07 | 88.79 | 87.87 | 109.7 | 101.9 |

Table 5 lists results for GLOBAL and LOCAL in YAGO15K. As for FB15K-237, LOCAL outperforms GLOBAL for most of the numerical attributes. Table 6 depicts the performance of LOCAL, NAP and NAP++ under different degrees of sparsity in YAGO15k. In view these numbers, NAP-based models are shown to be more robust than LOCAL to data sparsity. NAP++ achieves the best performance for most of the numerical attributes and degrees of sparsity. Indeed NAP++, on average, improves NAP's performance by 20 points (absolute value) with respect to the MAE metric.

TABLE 5
Performance of GLOBAL and LOCAL on YAGO15k

| | |
|---|---|
| GLOBAL | LOCAL |

| Num. Attribute | MAE | RMSE | MAE | RMSE |
|---|---|---|---|---|
| date_of_death | 37.99 | 89.47 | 39.70 | 92.38 |
| happenedOnDate | 38.55 | 67.33 | 38.55 | 67.33 |
| latitude | 12.51 | 21.50 | 3.04 | 9.04 |
| longitude | 53.07 | 63.195 | 11.38 | 24.08 |
| date_of_birth | 25.24 | 66.10 | 23.94 | 65.78 |
| createdOnDate | 89.32 | 155.83 | 132.20 | 197.18 |
| destroyedOnDate | 31.54 | 60.08 | 30.97 | 59.42 |

TABLE 6
Performance of LOCAL, NAP, NAP++ on YAGO15k
for different degrees of sparsity, Pᵣ, on the numerical
facts. Results are reported in terms of MAE.

| Percent Train | 100 | | | 80 | | |
|---|---|---|---|---|---|---|
| Attribute | LOCAL | NAP | NAP++ | LOCAL | NAP | NAP++ |
| date_of_death | 39.70 | 39.64 | 35.1 | 40.76 | 40.51 | 37.38 |
| happenedOnDate | 38.55 | 48.77 | 34.4 | 38.41 | 51.08 | 31.23 |
| latitude | 3.04 | 2.16 | 1.77 | 4.00 | 2.48 | 2.54 |
| longitude | 11.38 | 3.45 | 3.62 | 16.74 | 5.54 | 4.62 |
| date_of_birth | 23.94 | 18.32 | 16.91 | 24.16 | 18.69 | 17.49 |
| createdOnDate | 132.2 | 67.68 | 65.25 | 104.1 | 69.54 | 65.74 |
| destroyedOnDate | 30.97 | 25.61 | 21.63 | 31.45 | 25.98 | 25.98 |
| Percent Train | 50 | | | 20 | | |
| Attribute | LOCAL | NAP | NAP++ | LOCAL | NAP | NAP++ |
| date_of_death | 39.34 | 40.14 | 38.20 | 41.59 | 39.8 | 39.25 |
| happenedOnDate | 37.75 | 49.99 | 32.76 | 37.57 | 54.17 | 32.14 |
| latitude | 6.32 | 3.21 | 2.90 | 9.69 | 3.71 | 4.2 |
| longitude | 24.07 | 6.29 | 6.06 | 40.09 | 10.26 | 10.1 |
| date_of_birth | 24.39 | 18.79 | 18.07 | 25.70 | 20.12 | 18.82 |
| createdOnDate | 109.5 | 71.44 | 72.22 | 138.2 | 72.25 | 71.63 |
| destroyedOnDate | 30.67 | 24.42 | 21.17 | 31.4 | 27.80 | 26.5 |

To have another analysis of performance gains, error reduction between NAP++ and the best performing baseline was determined. For numerical attribute a, the percentage error reduction in MAE is computed as follows:

$${Δ}_{MAE} = \frac{min ( {MAE}_{LOCAL} ( a ) , {MAE}_{GLOBAL} ( a ) ) - {MAE}_{NAP ++} ( a )}{min ( {MAE}_{LOCAL} ( a ) , {MAE}_{GLOBAL} ( a ) )} \times 100$$

The percentage error reduction can be computed in terms of RMSE in a similar manner.

This is shown in Table 7 for Pᵣ=100. Overall, NAP++ significantly outperforms baselines for almost all numerical attributes in both FB15K-237 and YAGO15K data sets. These results demonstrate that the embeddings learned from the graph structure are useful predictors of entity numerical attributes.

TABLE 7
Percentage error reduction between NAP++ and
the best performing baseline for each numerical attribute
in FB15K-237 and YAGO15K. The higher the value, the
better the performance of NAP++ relative to the baselines.

| | FB15K-237 | | YAGO15K | |
|---|---|---|---|---|
| Num. Attribute | ΔMAE | ΔRMSE | ΔMAE | ΔRMSE |
| happenedOnDate | — | — | 18.53 | 31.89 |
| createdOnDate | — | — | 29.95 | 15.80 |
| destroyedOnDate | — | — | 30.11 | 43.80 |
| date_of_birth | 38.43 | 56.26 | 29.37 | 10.65 |
| latitude | 35.05 | 51.28 | 41.86 | 45.45 |
| longitude | −17.61 | −30.29 | 12.43 | 48.4 |
| date_of_death | 29.33 | 51.26 | 7.61 | 14.0 |
| person.height_mt | 12.94 | 11.54 | — | — |
| film_release_date | 63.71 | 62.60 | — | — |
| org.date_founded | 25.93 | 23.36 | — | — |
| location.date_founded | 27.03 | 22.31 | — | — |

Table 3 shows a noteworthy behavior of these methods with respect to the numerical attributes ‘date of birth’ and ‘date of death’. While the performance of both approaches is comparable in terms of MAE, their RMSE largely differ. It is known that the mean absolute error is an evaluation metric more robust to outliers than the root mean squared error. These outliers were inspected shed light on usefulness of incorporating numerical information in the embeddings.

NAP-based models leverage these embeddings to build a similarity graph on which numerical information is propagated. The resulting predictions are the result of multiplying the adjacency matrix by the observed numerical values. This matrix determines which observed entities' numerical values to pay attention to. These attention values are different for NAP and NAP++ as the graph similarity is constructed with different embeddings.

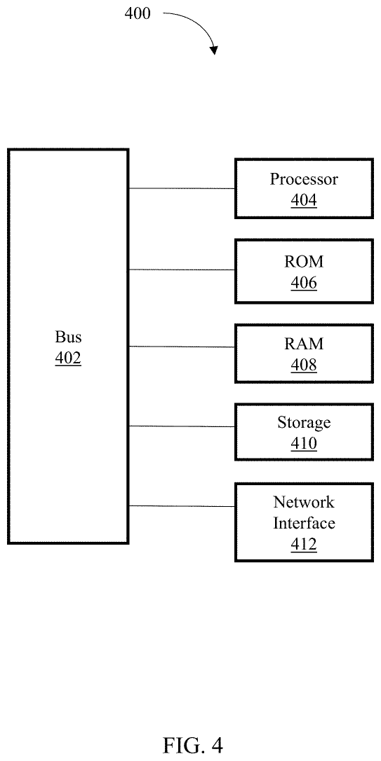

FIG. 4 is a block diagram of a processing system according to an embodiment. The processing system 400 is a specialized computer that has been specifically programmed and configured to implement the systems and methods described above. The processing system 400 includes a processor 404, such as a central processing unit (CPU) of a computing device or a distributed processor system. The processor 404 executes processor executable instructions comprising embodiments of the system for performing the functions and methods described above. In embodiments, the processor executable instructions are locally stored or remotely stored and accessed from a non-transitory computer readable medium, such as storage 410, which may be a hard drive, cloud storage, flash drive, etc. Read Only Memory (ROM) 406 includes processor executable instructions for initializing the processor 404, while the random-access memory (RAM) 408 is the main memory for loading and processing instructions executed by the processor 404. The network interface 412 may connect to a wired network or cellular network and to a local area network or wide area network, such as the Internet.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A method for learning numerical attributes in a knowledge graph, the method comprising:
learning knowledge graph embeddings based on jointly minimizing a knowledge graph loss and a number of numerical attribute prediction losses; and
executing a numerical attribute propagation algorithm using an adjacency matrix of the knowledge graph and numerical values of labeled nodes of the knowledge graph to predict missing ones of the numerical attributes.

2. The method of claim 1, wherein the numerical attribute propagation algorithm comprises:
computing a transition matrix T by row-wise normalizing the adjacency matrix;
using the transition matrix T to iteratively propagate the numerical values across the knowledge graph until a stopping criterion is reached.

3. The method of claim 1, wherein the numerical attribute propagation algorithm comprises solving:
\hat{n}_{Q}_{^{a}}^{a}=(I+T_{Q}_{^{a}}_{Q}_{^{a}})⁻¹T_{Q}_{^{a}}_{ε}_{^{a}}n_{ε}_{^{a}}^{a}
wherein a is a numerical attribute of the knowledge graph, ε^{a} is a set of entities of the knowledge graph with known values for the numerical attribute a, Q^{a} is a set of entities of the knowledge graph with missing values for the numerical attribute a, \hat{n}_{Q}_{^{a}}^{a} is a vector that contains all predicted values of the numerical attribute a for unlabeled nodes of the knowledge graph, I is an identity matrix, T_{Q}_{^{a}}_{Q}_{^{a}} and T_{Q}_{^{a}}_{ε}_{^{a}} are sub-matrices of a transition matrix T, which is computed by row-wise normalizing the adjacency matrix, and n_{ε}_{^{a}}^{a} is a vector that contains all values of the numerical attribute a for the labeled nodes.

4. The method of claim 1,
wherein the numerical attribute propagation algorithm is executed for each of the missing numerical attributes being predicted;
wherein for each of the missing numerical attributes a k-nearest neighbor (kNN) graph is calculated using the learned knowledge graph embeddings, the kNN graph for each of the missing numerical attributes being characterized by the adjacency matrix of the corresponding one of the missing numerical attributes, and
wherein edge weights of the adjacency matrix are computed by applying a similarity metric.

5. The method of claim 4, wherein the kNN graph is constructed based on Euclidian distance.

6. The method of claim 4, wherein the learned knowledge graph embeddings comprises learned knowledge graph embeddings of the labeled nodes and learned knowledge graph embeddings of unlabeled nodes of the knowledge graph.

7. The method of claim 4, wherein the similarity metric is a radial basis function kernel.

8. The method of claim 1, wherein the knowledge graph has entities containing the numerical attributes.

9. The method of claim 4, the method further comprising tuning a hyper-parameter of the kNN graph.

10. The method of claim 4, wherein the method comprises tuning a hyper-parameter of the similarity metric.

11. The method of claim 1, wherein the numerical attribute propagation algorithm is an adapted label propagation algorithm, adapted for predicting the numerical attributes in the knowledge graph.

12. The method of claim 11, wherein the adapted label propagation algorithm has been adapted to propagate the numerical information across the knowledge graph instead of propagating class label information.

13. The method of claim 1, wherein the learning the knowledge graph embeddings operation comprises using a regression model.

14. The method of claim 1, wherein the jointly minimizing the knowledge graph loss and the numerical attribute prediction losses comprises using a loss function [symbol] ,
wherein the loss function [symbol] is:
$$= {ℒ}_{KG} + {\sum }_{a ∈ A} {\sum }_{e ∈ {ɛ}^{a}} {( {e}^{T} {w}^{a} + {b}^{a} - {n}_{e}^{a} )}^{2} + {λ}_{a} {‖ {w}^{a} ‖}_{2}^{2}$$
wherein [symbol] _{KG} is a loss function of the knowledge graph, a is numerical attribute of a set of numerical attributes A of the knowledge graph, e is an entity of a set of entities ε^{a} of the knowledge graph with known values for the numerical attribute a, e^{T}w^{a}+b^{a} is a regression function for the numerical attribute a, λₐ is a regularization hyper-parameter, w^{a} is a weight vector, and b^{a} is a bias term.

15. A system for learning numerical attributes in a knowledge graph, the system comprising a processor and memory, the memory storing information that when executed causes the processor to:
instantiate a regression model to learn knowledge graph embeddings based on jointly minimizing a knowledge graph loss and a number of numerical attribute prediction losses; and
execute a numerical attribute propagation algorithm using an adjacency matrix of the knowledge graph and numerical values of labeled nodes of the knowledge graph to predict missing ones of the numerical attributes.
